(19) United States
(12) Patent Application Publication
(10) Pub. No.: US 2012/0100413 A1
(43) Pub. Date: Apr. 26, 2012

(54) SECONDARY BATTERY AND ASSEMBLED BATTERY

(75) Inventors: Satoshi OKANO, Osaka (JP); Yoshihiro TSUKUDA, Osaka (JP); Kazuo YAMADA, Osaka (JP)

(73) Assignee: SHARP KABUSHIKI KAISHA, Osaka (JP)

(21) Appl. No.: 13/271,341

(22) Filed: Oct. 12, 2011

(30) Foreign Application Priority Data
Oct. 21, 2010 (JP) 2010-236614

(51) Int. Cl. H01M 2/02; H01M 2/08

(52) U.S. Cl. 429/152; 429/185

(57) ABSTRACT

A secondary battery is provided that can be built into an assembled battery at lower cost than by building a secondary battery employing a laminate film into an assembled battery and that permits easy stacking. The secondary battery has: an electrode assembly including a positive electrode and a negative electrode; a package container including a package can in which the electrode assembly is housed and a lid member which seals an opening of the package can all around its circumference; and electrolyte liquid directly filling the housing container The outer bottom face of the housing container and the outer top face of the lid member are shaped such that one substantially fits into the other.

This nonprovisional application claims priority under 35 U.S.C. §119(a) on Patent Application No. 2010-236614 filed in Japan on Oct. 21, 2010, the entire contents of which are hereby incorporated by reference.

### BACKGROUND OF THE INVENTION

1. Field of the Invention

The present invention relates to a secondary battery, and to an assembled battery having a plurality of secondary batteries connected together.

2. Description of Related Art

In recent years, as consumer electronics, such as cellular phones, portable electronic appliances, personal digital assistants, are rapidly made compact, lightweight, and versatile, for use as their electric power sources there has been demand for the development of secondary batteries that are compact and lightweight, that offer high energy density, and that stand repeated charge-discharge cycles for a long period of time. As secondary batteries that meet those requirements, most promising are lithium-ion secondary batteries, which offer higher energy density than other secondary batteries, and a wide range of research is being conducted to develop lithium-ion secondary batteries with increasingly enhanced properties.

Moreover, in recent years, in view of environmental issues such as global warming, lithium-ion secondary batteries have been increasingly used for storage of electric power in solar power generation systems, wind power generation systems, and the like. Furthermore, as measures to reduce CO₂ emissions and cope with energy issues, there has been a high expectation for the spread of fuel-efficient, low-emission vehicles, such as hybrid electric vehicles (HEVs) and electric vehicles (EVs), and the development and commercialization of lithium-ion secondary batteries intended for use as vehicle-mounted batteries are underway.

As discussed above, the application of lithium-ion secondary batteries is no longer limited to portable appliances but is now widening into the driving of large motors. For lithium-ion secondary batteries to be used as motive power sources or in electric power storage systems, they need to have a large capacity to be capable of discharging for a long time, and thus they are typically used in the form of an assembled battery having a plurality of battery cells connected together. From the perspectives of handling and installation space, an assembled battery often has battery cells arranged or stacked into a module (see JP-A-2003-288883).

While secondary batteries, like that disclosed in JP-A-2003-288883, that employ a laminate film are inexpensive as battery cells, when these are assembled into a module as an assembled battery, since the film is not rigid enough to permit a plurality of battery cells to be stacked together, every predetermined number of battery cells need to be covered with a rigid package member such as a metal can. Then, a plurality of assembled batteries each covered in a package member to have a predetermined capacity are stacked together into an assembled battery as an end product. This requires a large number of components and high cost.

### SUMMARY OF THE INVENTION

An object of the present invention is to provide a secondary battery that can be built into an assembled battery at lower cost than by building a secondary battery employing a laminate film into an assembled battery and that permits easy stacking. Another object of the invention is to provide an assembled battery having such secondary batteries stacked together.

To achieve the above objects, according to one aspect of the invention, a secondary battery is provided with: an electrode assembly including a positive electrode and a negative electrode; a package container including a housing container in which the electrode assembly is housed and a lid member which seals an opening of the housing container all around the circumference thereof; and electrolyte liquid directly filling the housing container. Here, the outer bottom face of the housing container and the outer top face of the lid member are shaped such that one substantially fits into the other.

With this structure, it is possible to stack together a plurality of lithium-ion secondary batteries by fitting one into the next vertically, for use as an assembled battery.

In the secondary battery described above, it is preferable that the outer bottom face of the housing container and a recess formed in the outer top face of the lid member be shaped such that one substantially fits into the other.

In the secondary battery described above, it is preferable that the outer bottom face of the housing container be substantially rectangular, and that the recess in the lid member be substantially rectangular and larger than the outer bottom face of the housing container.

In the secondary battery described above, it is preferable that the opening of the housing container be sealed with the lid member by seam sealing.

According to another aspect of the invention, an assembled battery is built by stacking together a plurality of secondary batteries as described above with the outer bottom face of one housing container fitted into the outer top face of the adjacent lid member.

In the assembled battery described above, it is preferable to further provide a cushioning member between the outer bottom face of one housing container and the outer top face of an adjacent lid member.

In the assembled battery described above, it is preferable to further provide a clamping member which clamps at least the bottommost and topmost secondary batteries against each other.

In the assembled battery described above, it is preferable that the clamping member have a top face member which traverses the outer top face of the topmost secondary battery, and that space be left between the top face member and the outer top face of the topmost secondary battery.

In the assembled battery described above, it is preferable that the secondary batteries each have a capacity of 10 Ah or more.

According to the present invention, in a secondary battery, the outer bottom face of the housing container and the outer top surface of the lid member are so shaped that one substantially fits into the other. Thus, it is possible to stack together a plurality of secondary batteries by fitting one into the next vertically for use as an assembled battery. The assembled battery of this type, compared with an assembled battery formed by stacking together secondary batteries (battery cells) employing a laminate film, has sufficient rigidity in the package container, and thus does not need to be covered in a package member such as a metal can even when a considerable number of battery cells are stacked together. Thus, simply stacking together a number of battery cells to obtain the desired capacity permits their use as an assembled battery. This helps reduce the number of components and reduce cost.

### BRIEF DESCRIPTION OF THE DRAWINGS

FIG. 1 is an exploded perspective view of a lithium-ion secondary battery according to Embodiment 1 of the invention;

FIG. 2 is an exploded perspective view of a lithium-ion secondary battery according to Embodiment 1 of the invention;

FIG. 3 is an overall perspective view of a lithium-ion secondary battery according to Embodiment 1 of the invention;

FIG. 4 is a top view of a lithium-ion secondary battery according to Embodiment 1 of the invention;

FIG. 5 is a perspective view showing the structure of an electrode assembly in a lithium-ion secondary battery according to Embodiment 1 of the invention;

FIG. 6 is a perspective view showing the structure of a positive electrode in a lithium-ion secondary battery according to Embodiment 1 of the invention;

FIG. 7 is a plan view showing the structure of a positive electrode in a lithium-ion secondary battery according to Embodiment 1 of the invention;

FIG. 8 is a perspective view showing the structure of a negative electrode in a lithium-ion secondary battery according to Embodiment 1 of the invention;

FIG. 9 is a plan view showing the structure of a negative electrode in a lithium-ion secondary battery according to Embodiment 1 of the invention;

FIG. 10 is a sectional view showing the structure of an electrode assembly in a lithium-ion secondary battery according to Embodiment 1 of the invention;

FIG. 11 is a perspective view of a package can in a lithium-ion secondary battery according to Embodiment 1 of the invention;

FIG. 12 is a top view of a package can in a lithium-ion secondary battery according to Embodiment 1 of the invention;

FIG. 13 is a sectional view taken along line A-A in FIG. 3;

FIG. 14 is a front sectional view of an assembled battery according to Embodiment 2 of the invention;

FIG. 15 is a front sectional view of an assembled battery according to Embodiment 3 of the invention;

FIG. 16A is a front view of an assembled battery according to Embodiment 4 of the invention;

FIG. 16B is a top view of an assembled battery according to Embodiment 4 of the invention; and

FIG. 16C is a side view of an assembled battery according to Embodiment 4 of the invention.

### DETAILED DESCRIPTION OF PREFERRED EMBODIMENTS

Below, embodiments will be described where the present invention is applied to a stacked-type lithium-ion secondary battery as an example of a secondary battery.

### Embodiment 1

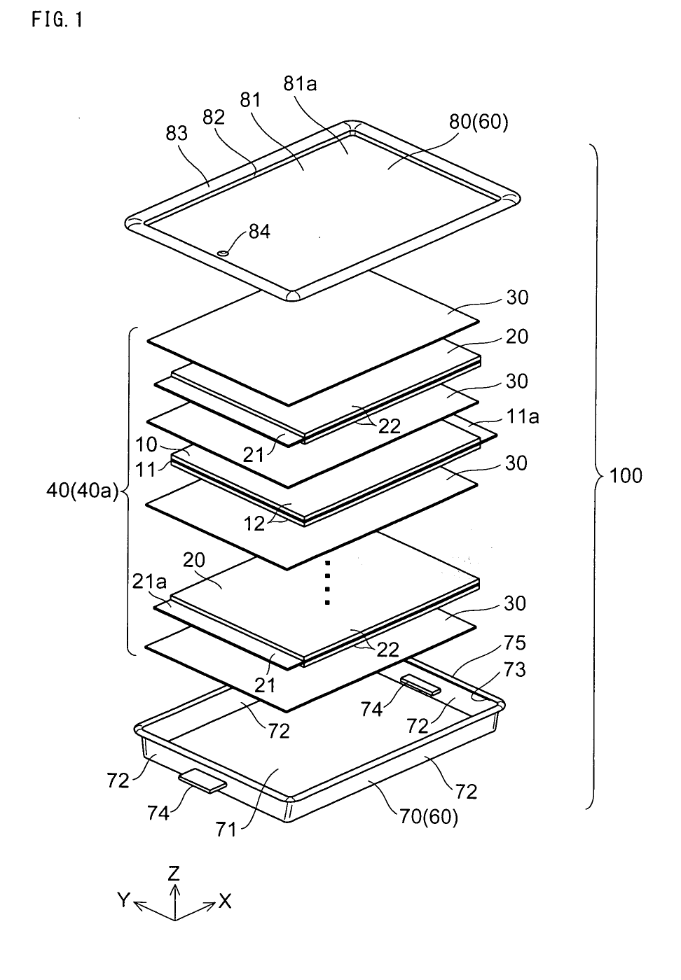

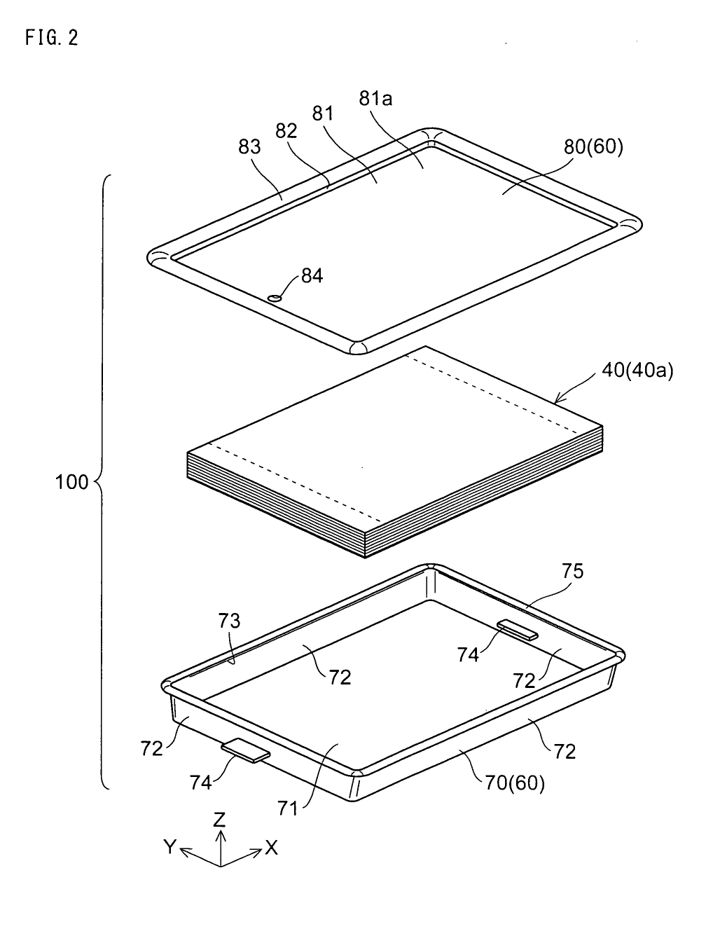

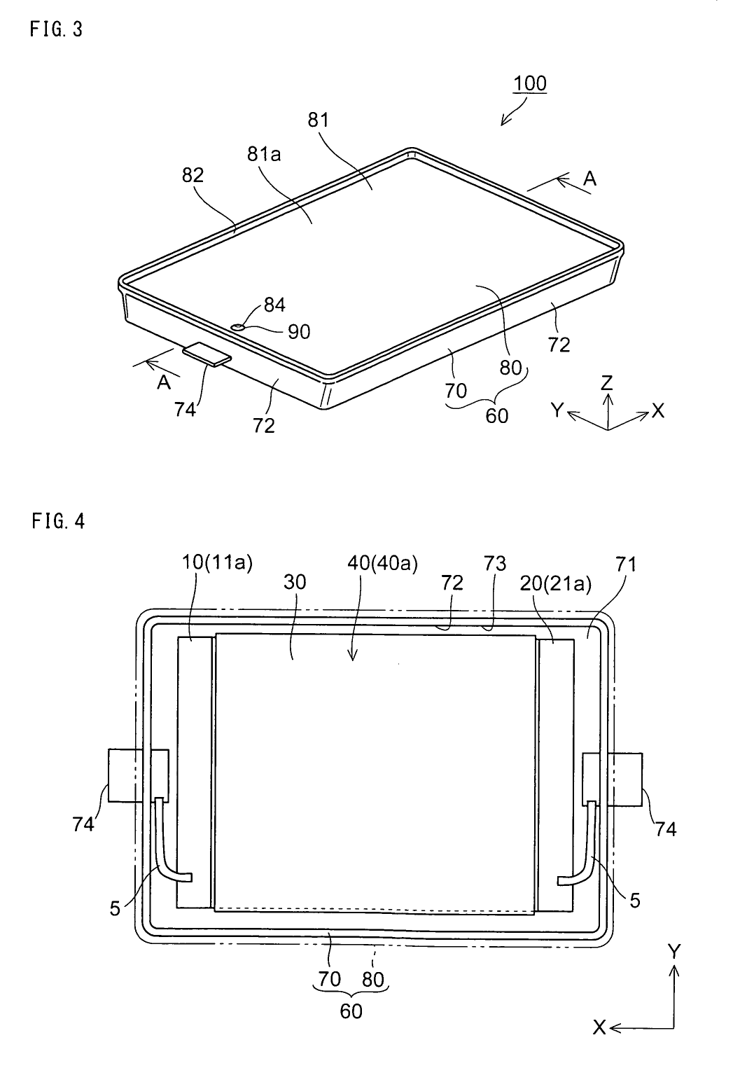

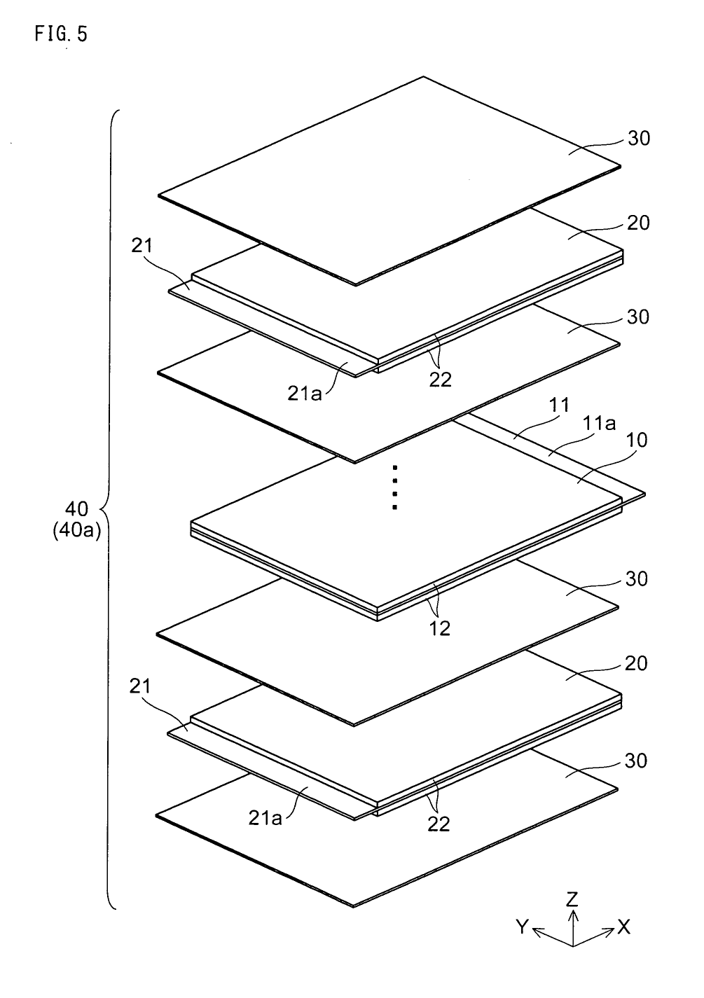

FIGS. 1 and 2 are exploded perspective views of a lithium-ion secondary battery according to a first embodiment (Embodiment 1) of the invention. FIG. 3 is an overall perspective view of the lithium-ion secondary battery according to Embodiment 1 of the invention. FIG. 4 is a plan view of the lithium-ion secondary battery according to Embodiment 1 of the invention. FIGS. 5 to 13 are diagrams in illustration of the lithium-ion secondary battery according to Embodiment 1 of the invention. It should be noted that FIG. 4 shows the lithium-ion secondary battery without the lid plate 80 which it ordinarily has, in order to show the inside of the battery.

As shown in FIGS. 1 to 4, the lithium-ion secondary battery 100 according Embodiment 1 has a flat, rectangular shape (see FIG. 3), and includes an electrode assembly 40 (see FIGS. 1 and 2), which in turn includes a positive electrode 10 (see FIG. 1) and a negative electrode 20 (see FIG. 1), and a metal package container 60, in which the electrode assembly 40 is sealed along with a non-aqueous electrolyte liquid. The positive and negative electrodes 10 and 20 are an example of “electrodes” according to the invention.

As shown in FIGS. 1 and 5, the electrode assembly 40 further includes a separator 30 for preventing short-circuiting between the positive and negative electrodes 10 and 20. The positive and negative electrodes 10 and 20 are arranged so as to face each other across the separator 30. Typically, the electrode assembly 40 includes a plurality of positive electrodes 10, a plurality of negative electrodes 20, and a plurality of separators 30. The positive electrodes 10, the separators 30, and the negative electrodes 20 are stacked sequentially to form a stacked structure (stacked member 40a). The positive and negative electrodes 10 and 20 are stacked alternately, one of the former on one of the latter and vice versa. The electrode assembly 40 is so composed that, between every two adjacent negative electrodes 20, one positive electrode 10 is located. Moreover, the electrode assembly 40 has separators 30 arranged on the outermost sides thereof.

The electrode assembly 40 is composed of, for example, twenty-four (24) positive electrodes 10, twenty-five (25) negative electrodes 20, and fifty (50) separators 30, with the positive and negative electrodes 10 and 20 stacked alternately with the separators 30 interposed between them.

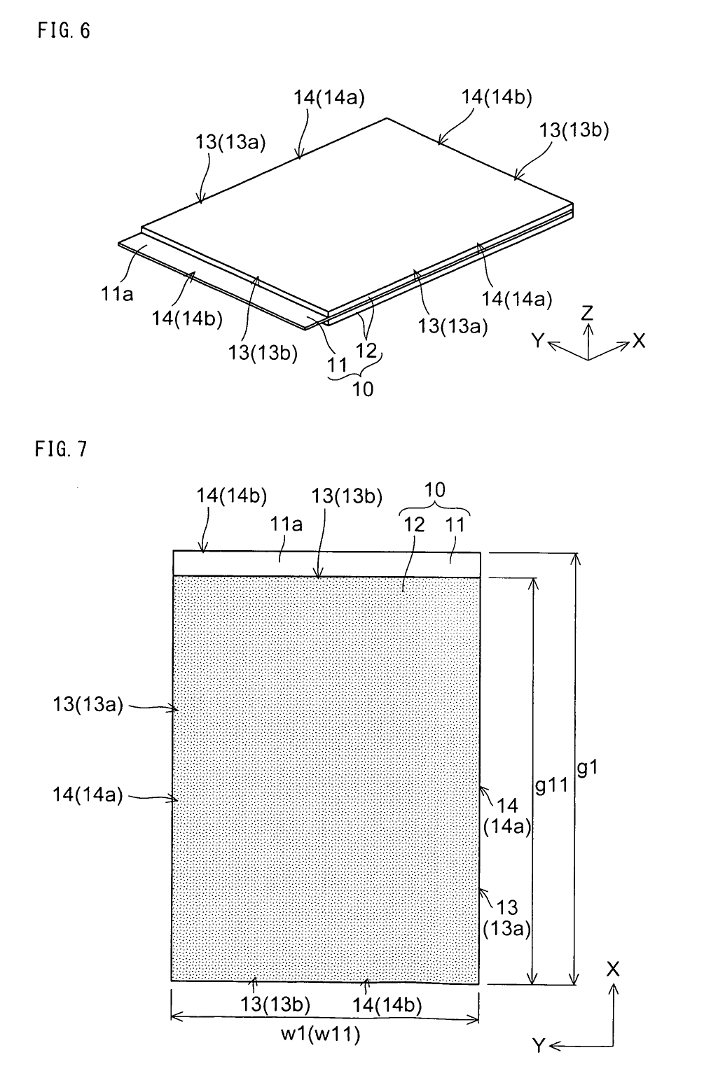

As shown in FIGS. 6 and 7, each positive electrode 10 in the electrode assembly 40 is composed of a positive electrode charge collector 11 having a positive electrode active material layer 12 laid on each face.

The positive electrode charge collector 11 serves to collect electric charge from the positive electrode active material layer 12. The positive electrode charge collector 11 is formed of, for example, a foil of metal such as aluminum, titanium, stainless steel, nickel, or iron, or a foil of an alloy of any of these metals, and has a thickness of about 1 μm to about 500 μm (for example, about 20 μm). Preferably, the positive electrode charge collector 11 is formed of a foil of aluminum or a foil of an alloy of aluminum, and is given a thickness of 20 μm or less.

The positive electrode charge collector 11 may be formed of, other than the materials mentioned above, metal such as aluminum or copper having its surface treated with carbon, nickel, titanium, silver, or the like for increased electrical conductivity and resistance to oxidation. These materials may have their surface oxidation-treated. Also usable are a copper-aluminum clad material, a stainless steel-aluminum clad material, or a plated material that is a combination of any of these metals. A charge collector may also be used that has foils of two or more metals bonded together. The positive electrode charge collector 11 may be other than foil-shaped; it may instead be film-shaped, sheet-shaped, or net-shaped; punched, or expanded; shaped like a lath member, a porous member, or a foamed member; or shaped like a member formed of clusters of fibers.

The positive electrode active material layer 12 is so formed as to contain a positive electrode active material that can occlude and release lithium ions. Examples of positive electrode active materials include oxides containing lithium; specifically, they include LiCoO₂, LiFeO₂, LiMnO₂, LiMn₂O₄, and any compound obtained by substituting part of the transition metal in any of these oxides with another metal element. Among these, preferable as the positive electrode active material are those which allow 80% or more of the lithium contained in the positive electrode to be used in the cell reaction under normal use. This makes it possible to enhance the safety of the secondary battery against accidents such as overcharging.

Examples of such positive electrode active materials include compounds having a spinel structure, such as LiMn₂O₄; and compounds having an olivine structure represented by the formula LiMPO₄ (where M represents one or more elements selected from the group consisting of Co, Ni, Mn, and Fe). Among these, positive electrode active materials containing at least one of Mn and Fe are preferable from the viewpoint of cost. From the viewpoint of safety and charge voltage, it is preferable to use LiFePO₄. In LiFePO₄, all oxygen (O) atoms are bonded to phosphorus (P) atoms by strong covalent bond, and thus oxygen is unlikely to be released on a rise in temperature; this makes LiFePO₄ excellent in safety.

Preferably, the positive electrode active material layer 12 is given a thickness of about 20 μm to about 2 mm, and further preferably from about 50 μm to about 1 mm.

The positive electrode active material layer 12 has at least to contain a positive electrode active material and there is no other particular restriction on its composition. For example, the positive electrode active material layer 12 may further include, in addition to a positive electrode active material, any other material such as a conductive agent (electrical conductivity enhancer), a thickening agent (viscosity modifier), and a binding agent (binder).

Any conductive agent may be used so long as it is an electron conducting material that does not adversely affect the performance of the positive electrode 10 in the battery. Examples include carbon materials such as carbon black, acetylene black, Ketjen black, graphite (natural and artificial), and carbon fiber; and conductive metal oxides. Among these, preferable as a conductive agent from the viewpoints of electron conduction and ease of application are carbon black and acetylene black.

Examples of thickening agents include polyethylene glycols, celluloses, polyacrylamides, poly-N-vinylamides, and poly-N-vinylpyrrolidones. Among these, preferable as a thickening agent are polyethylene glycols, and celluloses such as carboxymethyl cellulose (CMC), CMC being particularly preferable.

A binding agent serves to bind active material particles and conductive agent particles, and examples include fluorine polymers such as polyvinylidene fluoride (PVdF), polyvinyl pyridine, and polytetrafluoroethylene; polyolefin polymers such as polyethylene and polypropylene; and styrene-butadiene rubber.

Examples of solvents in which a positive electrode active material, a conductive agent, a binding agent, etc. are dispersed include organic solvents such as N-methyl-2-pyrrolidone, dimethylformamide, dimethylacetamide, methylethyl ketone, cyclohexanone, methyl acetate, methyl acrylate, diethyltriamine, N,N-dimethylaminopropylamine, ethylene oxide, and tetrahydrofuran.

The positive electrode 10 is formed, for example, in the following manner. A positive electrode active material, a conductive agent, a thickening agent, and a binding agent are blended, and an appropriate solvent is added to the blend to prepare a positive electrode composite agent in the form of paste; the paste is applied to the surface of the positive electrode charge collector 11 and is dried; as necessary, the product is compressed for increased electrode density.

As shown in FIG. 7, the positive electrode 10 has a rectangular shape as seen in a plan view, and has four edge portions 14 (two edge portions 14a in the X direction and two edge portions 14b in the Y direction). In Embodiment 1, the positive electrode 10 has a Y-direction width w1 of, for example, about 146 mm, and has an X-direction length g1 of, for example, about 208 mm. The region over which the positive electrode active material layer 12 is applied (the application region, or the formation region) has a Y-direction width w11 of, for example, about 146 mm, which is equal to the width w1 of the positive electrode 10, and has an X-direction length g11 of, for example, about 196 mm. Thus, the positive electrode active material layer 12 formed in the application region has a rectangular shape as seen in a plan view, and has four edge portions 13 (two edge portions 13a along the X direction and two edge portions 13b along the Y direction).

The positive electrode 10 has, at one end in the X direction, a charge collector-exposed portion 11a where the positive electrode active material layer 12 is not formed and the surface of the positive electrode charge collector 11 is exposed. To the charge collector-exposed portion 11a is electrically connected a charge collection lead 5 (see FIG. 4), which will be described later, for extraction of electric current. The four edge portions 13 of the positive electrode active material layer 12 align with the edge portions 14 of the positive electrode 10 except one of the two edge portions 13b along the Y direction (the edge portion 13b at which the charge collector-exposed portion 11a is located).

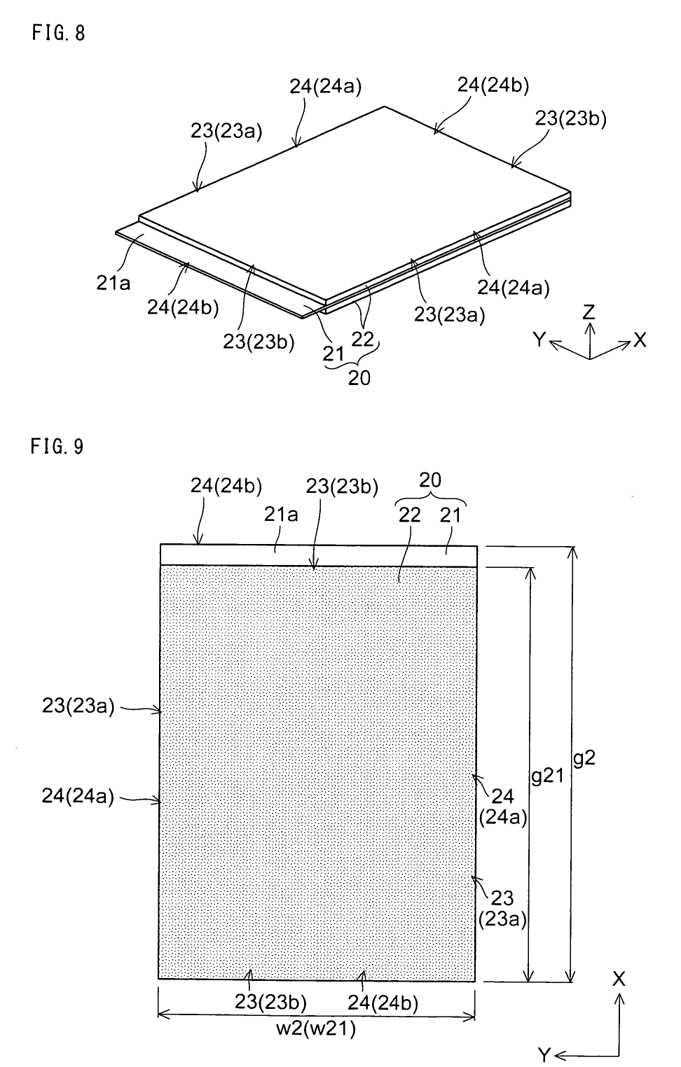

As shown in FIGS. 8 and 9, each negative electrode 20 in the electrode assembly 40 is composed of a negative electrode charge collector 21 having a negative electrode active material layer 22 laid on each face.

The negative electrode charge collector 21 serves to collect electric charge from the negative electrode active material layer 22. The negative electrode charge collector 21 is formed of, for example, a foil of metal such as copper, nickel, stainless steel, iron, or a plated nickel layer, or a foil of an alloy of any of these metals, and has a thickness of about 1 μm to about 100 μm (for example, about 16 μm). Preferably, the negative electrode charge collector 21 is formed of a foil of copper or stainless steel, and is given a thickness of 4 μm or more but 20 μm or less.

The negative electrode charge collector 21 may be other than foil-shaped; it may instead be film-shaped, sheet-shaped, or net-shaped; punched, or expanded; shaped like a lath member, a porous member, or a foamed member; or shaped like a member formed of clusters of fiber.

The negative electrode active material layer 22 is so formed as to contain a negative electrode active material that can occlude and release lithium ions. Examples of negative electrode active materials include substances containing lithium and substances that can occlude and release lithium. To build a high energy density battery, it is preferable to use a material of which the potentials at which lithium is occluded and released are close to the potentials at which metal lithium deposits and dissolves. Typical examples of such materials include natural and artificial graphite in the form of particles (that is, in the form of scales, lumps, fibers, whiskers, spheres, crushed particles, and the like).

Also usable as a negative electrode active material is artificial graphite obtained by graphitizing mesocarbon microbeads, mesophase pitch powder, isotropic pitch powder, or the like. It is also possible to use graphite particles whose surface is coated with amorphous carbon. Also usable are lithium transition metal oxides, lithium transition metal nitrides, transition metal oxides, silicon oxides, and the like. Examples of lithium transition metal oxides include lithium titanates as exemplified by Li₄Ti₅O₁₂, whose use reduces degradation of the negative electrode 20 and thus helps prolong the life of the battery.

Preferably, the negative electrode active material layer 22 is given a thickness of about 20 μm to about 2 mm, and further preferably from about 50 μm to about 1 mm.

The negative electrode active material layer 22 has at least to contain a negative electrode active material and there is no other particular restriction on its composition. For example, the negative electrode active material layer 22 may further include, in addition to a negative electrode active material, any other material such as a conductive agent (electrical conductivity enhancer), a thickening agent (viscosity modifier), and a binding agent (binder). Usable as these other materials are the same as those usable in the positive electrode active material layer 12.

The negative electrode 20 is formed, for example, in the following manner. A negative electrode active material, a conductive agent, a thickening agent, and a binding agent are blended, and an appropriate solvent is added to the blend to prepare a negative electrode composite agent in the form of paste; the paste is applied to the surface of the negative electrode charge collector 21 and is dried; as necessary, the product is compressed for increased electrode density.

As shown in FIG. 9, the negative electrode 20 has a rectangular shape as seen in a plan view, and has four edge portions 24 (two edge portions 24a in the X direction and two edge portions 24b in the Y direction). Moreover, the negative electrode 20 is formed to have a greater planar area than the positive electrode 10 (see FIGS. 7 and 8). In Embodiment 1, the negative electrode 20 has a Y-direction width w2 of, for example, about 150 mm, which is greater than the width w1 (see FIG. 7) of the positive electrode 10, and has an X-direction length g2 of, for example, about 210 mm, which is greater than the length g1 (see FIG. 7) of the positive electrode 10.

The region over which the negative electrode active material layer 22 is applied (the application region, or the formation region) has a Y-direction width w21 of, for example, about 150 mm, which is equal to the width w2 of the negative electrode 20, and has an X-direction length g21 of, for example, about 200 mm. Thus, the negative electrode active material layer 22 formed in the application region has a rectangular shape as seen in a plan view, and has four edge portions 23 (two edge portions 23a along the X direction and two edge portions 23b along the Y direction).

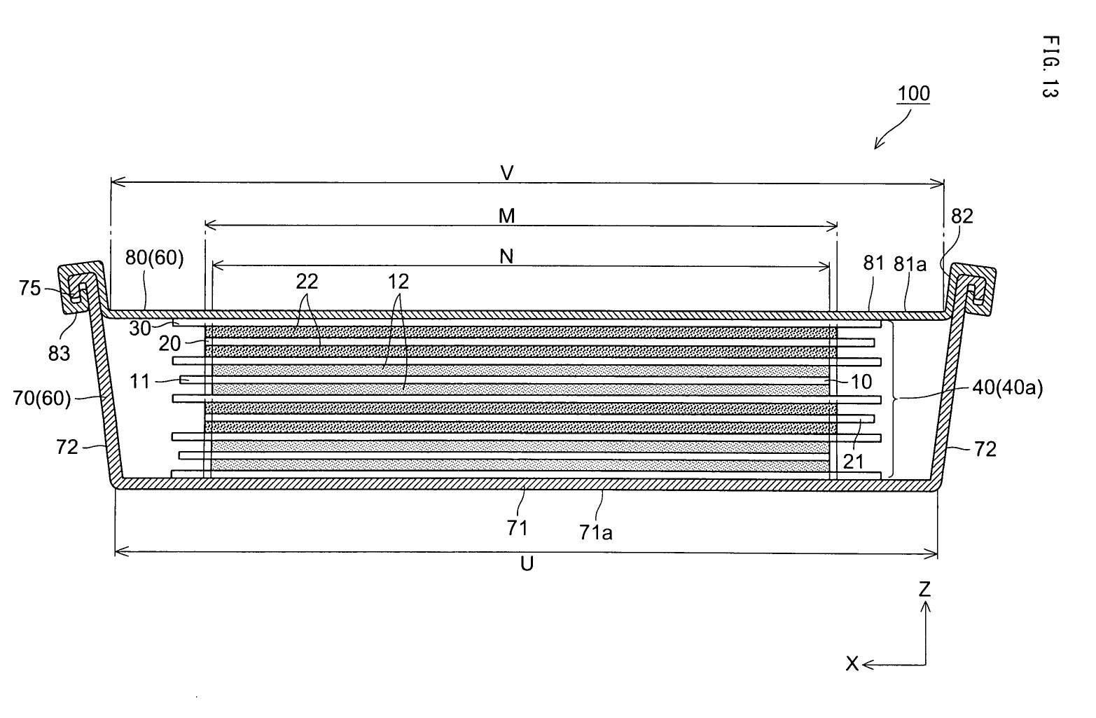

Like the positive electrode 10, the negative electrode 20 has, at one end in the Y direction, a charge collector-exposed portion 21 a where the negative electrode active material layer 22 is not formed and the surface of the negative electrode charge collector 21 is exposed. To the charge collector-exposed portion 21a is electrically connected a charge collection lead 5 (see FIGS. 4 and 12) for extraction of electric current. The four edge portions 23 of the negative electrode active material layer 22 align with the edge portions 24 of the negative electrode 20 except one of the two edge portions 23b along the Y direction (the edge portion 23b at which the charge collector-exposed portion 21a is located).

The separators 30 in the electrode assembly 40 are expected to provide sufficient rigidity and hold as much electrolyte liquid as possible. From this viewpoint, examples of preferable materials include microporous film and nonwoven fabric of materials such as polyethylene, polypropylene, and ethylene-propylene copolymer with a thickness of 10 gm to 50 μm and with a porosity (void percentage) of 30% to 70%.

Other examples of the material for the separators 30 include microporous film and the like formed of high polymers such as polyvinylidene fluoride, polyvinylidene chloride, polyacrylnitrile, polyacrylamide, polytetrafluoroethylene, polysulfone, polyethersulfone, polycarbonate, polyamide, polyimide, polyether (polyethylene oxide, polypropylene oxide), cellulose (carboxymethyl cellulose, hydroxypropyl cellulose), poly(meth)acrylic acid, and poly(meth)acrylic acid esters. A multilayer film may be used that has two or more such microporous films stacked together.

Preferably, each separator 30 is given a thickness of 5 μm to 100 μm, and further preferably 10 μm to 30 μm. Preferably, the separator 30 is given a porosity of 30% to 90%, and further preferably 40% to 80%. With the thickness of the separator 30 less than 5 μm, it has insufficient rigidity, causing internal short-circuiting of the battery. On the other hand, with the thickness of the separator 30 more than 100 μm, the distance between the positive and negative electrodes is so great that the battery has a high internal resistance. With a porosity less than 30%, the amount of non-aqueous electrolyte liquid contained is so small that the battery has a high internal resistance. On the other hand, with a porosity more than 90%, the positive and negative electrodes 10 and 20 make physical contact with each other, causing internal short-circuiting of the battery. Depending on their thickness and porosity, the separators 30 may be used in stacks of several sheets of them, with consideration given to rigidity, the amount of non-aqueous electrolyte liquid contained, the internal resistance of the battery, the likelihood of internal short-circuiting of the battery, and other factors.

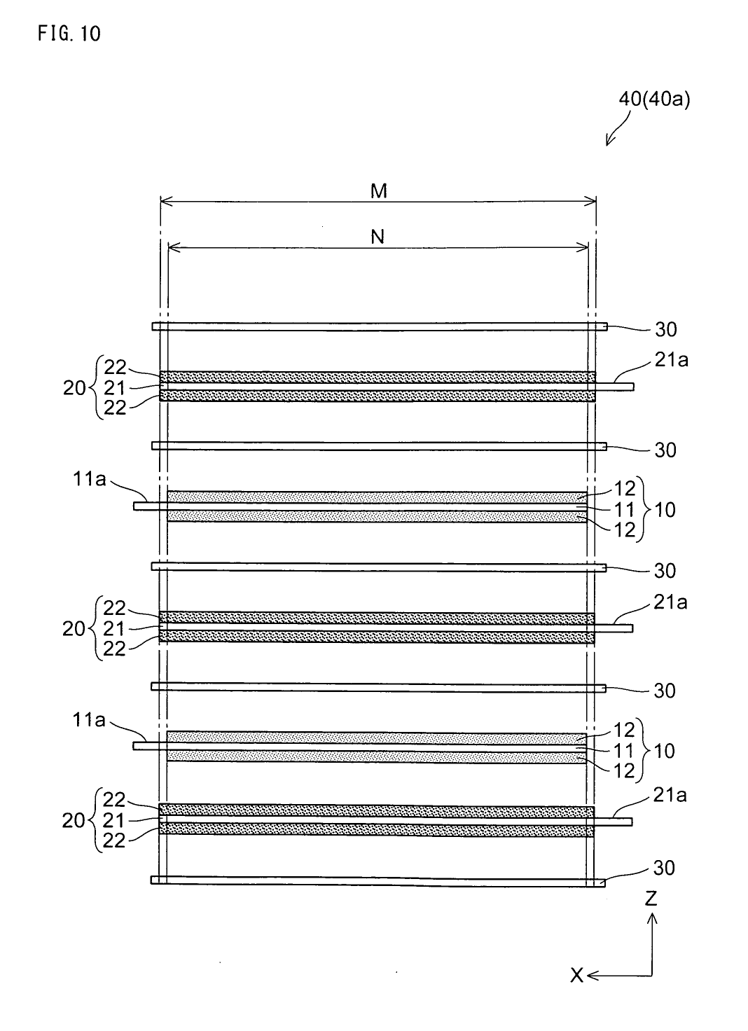

As shown in FIG. 10, the separator 30 is so shaped as to be larger than the application region (formation region N) of the positive electrode active material layer 12 and larger than the application region (formation region M) of the negative electrode active material layer 22. Specifically, the separator 30 is formed to have a rectangular shape with a longitudinal dimension (length in the direction corresponding to the X direction) of about 154 mm and a lateral dimension (length in the direction corresponding to the Y direction) of about 206 mm.

The positive and negative electrodes 10 and 20 are arranged so that the charge collector-exposed portion 11a of the positive electrodes 10 and the charge collector-exposed portion 21a of the negative electrodes 20 are located at opposite sides, and are stacked with the separators 30 interposed between the positive and negative electrodes.

There is no particular restriction on the non-aqueous electrolyte liquid sealed inside the package container 60 along with the electrode assembly 40. Examples of usable solvents include esters such as ethylene carbonate (EC), propylene carbonate, butylene carbonate, diethyl carbonate (DEC), dimethyl carbonate, methyl ethyl carbonate, and gamma-butyrolactone; ethers such as tetrahydrofuran, 2-methyltetrahydrofuran, dioxane, dioxolane, diethylether, dimethoxymethane, diethoxyethane, and methoxyethoxy ethane; and polar solvents such as dimethyl sulfoxide, sulfolane, methyl sulfolane, acetonitrile, methyl formate, and methyl acetate. Any of these solvents may be used singly or as a mixed solvent of two or more of them.

The non-aqueous electrolyte liquid may contain an electrolyte supporting salt. Examples of electrolyte supporting salts include lithium salts such as LiClO₄, LiBF₄ (lithium tetrafluoroborate), LiPF₆ (lithium hexafluorophosphate), LiCF₃SO₃ (lithium trifluoromethanesulfonate), LiF (lithium fluoride), LiCl (lithium chloride), LiBr (lithium bromide), LiI (lithium iodide), and LiAlCl₄ (lithium tetrachloroaluminate). Any of these may be used singly or as a mixture of two or more of them.

There is no particular restriction on the concentration of an electrolyte supporting salt, a preferable concentration being from 0.5 mol/L (mol per liter) to 2.5 mol/L, and further preferably from 1.0 mol/L to 2.2 mol/L. With the concentration of an electrolyte supporting salt less than 0.5 mol/L, the concentration of charge carriers in the non-aqueous electrolyte liquid may be so low that the non-aqueous electrolyte liquid has a high resistance. With the concentration of an electrolyte supporting salt more than 2.5 mol/L, the degree of dissociation of the salt itself may be so low that the concentration of carriers in the non-aqueous electrolyte liquid remains low.

The package container 60, in which the electrode assembly 40 is sealed, is a large, flat, rectangular container and, as shown in FIGS. 1 to 3, is composed of a package can 70 in which the electrode assembly 40 etc. are housed and a lid plate 80 which seals the opening of the package can 70. The package can 70 having the electrode assembly 40 housed in it is sealed with the lid plate 80 by seam sealing (preferably, double-seam sealing). The package can 70 is an example of a “housing container” according to the invention, and the lid plate 80 is an example of a “lid member” according to the invention.

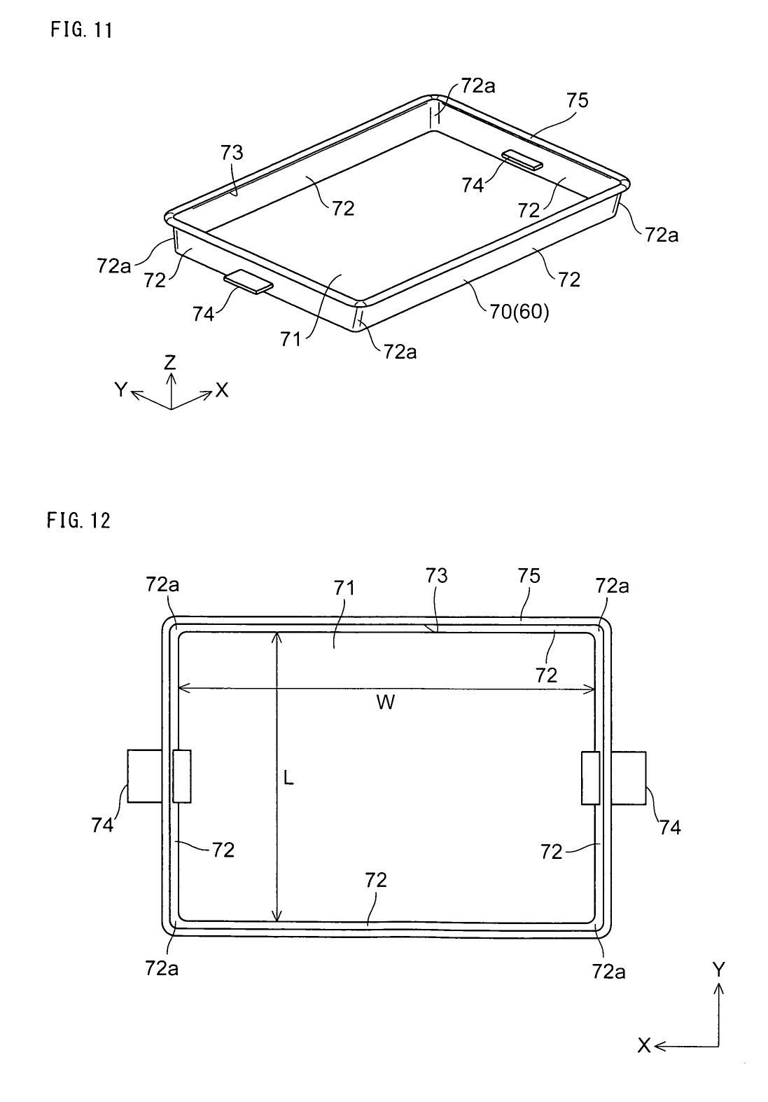

The package can 70 is formed, for example, by subjecting a metal plate to deep drawing, and has a bottom face portion 71 and a side wall portion 72. Moreover, as shown in FIGS. 11 and 12, the package can 70 has, at one end (on the side opposite from the bottom face portion 71), an opening 73 through which to house the electrode assembly 40. The package can 70 is formed as a box-shaped can, and the bottom face portion 71, which is substantially rectangular, has a larger area than the opening 73, which also is substantially rectangular. That is, the four corner portions 72a of the side wall portion 72 widen linearly from the bottom face portion 71 side to the opening 73 side.

The package can 70 has inside dimensions such that the electrode assembly 40 can be housed in it with the electrode surfaces facing the bottom face portion 71. Specifically, the package can 70 is formed to have, for example, a longitudinal dimension (length L in the Y direction in FIG. 12) of about 164 mm and a lateral dimension (length W in the X direction in FIG. 12) of about 228 mm. The package can 70 is given a depth of, for example, about 20 mm.

Moreover, in the package can 70, on parts of the side wall portion 72 parallel to the Y direction, there are formed electrode terminals 74 one each. Furthermore, around the rim of the opening 73 of the package can 70, there is provided a container flange portion 75 for seam sealing (preferably, double-seam sealing).

The lid plate 80 is formed, for example, by pressing of a metal plate. As shown in FIG. 2, the lid plate 80 has a panel portion 81, which is substantially flat-plate-shaped and stops the opening 73 of the package can 70, a chuck wall portion 82, which connects to the circumferential edge of the panel portion 81 and extends upward therefrom, and a flange portion 83, which connects to the circumferential edge of the chuck wall portion 82. Moreover, as shown in FIGS. 2 and 3, at one side in the X direction, there is formed a filling hole 84 through which to inject non-aqueous electrolyte liquid. The filling hole 84 is formed with a diameter of, for example, 2 mm.

The package can 70 and the lid plate 80 are formed of, for example, a metal plate of iron, stainless steel, aluminum, or the like, or a steel plate of nickel-plated iron, or a steel plate of aluminum-plated iron, or the like. Iron is inexpensive, and is preferable from the viewpoint of cost; however, to secure reliability for a long period of time, it is further preferable to use a metal plate of stainless steel, aluminum, or the like, or a steel plate of nickel-plated iron, or a steel plate of aluminum-plated iron, or the like. Other than these materials, also usable is a high-polymer-laminated material (laminated plate), that is, a metal plate having its surface laminated with a high-polymer material. In that case, it is preferable that at least the surface facing the inside of the battery be coated. The metal plate is given a thickness of, for example, about 0.4 mm to about 1.2 mm (for example, about 1.0 mm).

As shown in FIG. 4, the electrode assembly 40 is housed inside the package can 70 with the positive electrodes 10 (see FIG. 5) and the negative electrodes 20 (see FIG. 5) facing the bottom face portion 71 of the package can 70. Moreover, as shown in FIG. 4, the charge collector-exposed portion 11a (see FIG. 7) of the positive electrodes 10 and the charge collector-exposed portion 21a (see FIG. 9) of the negative electrode 20 are electrically connected, via charge collection leads 5 respectively, to the electrode terminals 74 on the package can 70. The charge collection leads 5 may be formed of the same material as, or a different material from, the charge collectors.

As shown in FIG. 13, the opening 73 of the package can 70 is sealed with the lid plate 80 by double-seam sealing. Specifically, the edge portion of the flange portion 83 of the lid plate 80 is crimped in such a way as to enfold the container flange portion 75 of the package can 70, and thereby the lid plate 80 is fitted to the package can 70. The lid plate 80 seals the opening 73 all around its circumference. Here, a sealing material (not illustrated) may be applied to the crimped parts; this helps obtain better air-tightness.

The chuck wall portion 82 allows the panel portion 81 of the lid plate 80 to be located a predetermined distance below the rim of the opening 73 of the package can 70 (toward the bottom face portion 71). Thus, when the electrode assembly 40 (stacked member 40a) is housed in the package container 60, the package can 70 and the lid plate 80 apply a pressing force to the electrode assembly 40 in its stack direction (the direction of the depth of the package can 70, which is the Z direction), and this holds the positive and negative electrodes 10 and 20 closely together, with the separators 30 interposed between them.

As shown in FIG. 13, the lateral-direction (X-direction) length U of the outer bottom face 71a, that is, the outer face of the bottom face portion 71, is slightly smaller than the lateral-direction (X-direction) length V of the outer top face 81a, that is, the outer face of the panel portion 81. Likewise, the longitudinal-direction (Y-direction) length of the outer bottom face 71a is slightly smaller than the longitudinal-direction (Y-direction) length of the outer top face 81a. Thus, the recess formed by the outer top face 81a and the outer bottom face 71a are so shaped that the latter substantially fits into the former. This permits a plurality of lithium-ion secondary batteries 100 to be stacked by being fitted one into the next, for use as an assembled battery. Preferably, the depth of the recess formed by the panel portion 81 and the chuck wall portion 82 (the height of the chuck wall portion 82) after sealing is about 1 mm to about 20 mm.

After the opening 73 of the package can 70 is sealed with the lid plate 80, non-aqueous electrolyte liquid is injected through the filling hole 84, for example, under reduced pressure. Then, for example, a metal ball 90 (see FIG. 3) with approximately the same diameter as the filling hole 84 is placed in the filling hole 84, and the filling hole 84 is sealed by electric resistance welding, laser welding, or the like.

In the lithium-ion secondary battery 100 according to Embodiment 1, to prevent risks such as rupture of the battery that may result from a rise in the internal pressure of the battery due to overcharging or high temperature, there is provided a safety valve (not shown) for liberating the internal pressure of the battery. And, to prevent the package container 60 from breaking open before activation of the safety valve, the lid plate 80 is fitted with such sealing strength that the pressure resistance at the sealed part is higher than the activation pressure of the safety valve.

The lithium-ion secondary battery 100 according to Embodiment 1 structured as described above can be used suitably as a stationary electric power storage battery which is expected to have a long life. It can also be used suitably as a vehicle-mounted storage battery for hybrid electric vehicles (HEVs), electric vehicles (EVs), and the like. The lithium-ion secondary battery 100 according to Embodiment 1 is suitable as a storage battery with a per-cell capacity of 10 Ah or more, and is particularly suitable as a large-capacity storage battery with a per-cell capacity of 50 Ah or more.

Below, a practical example of the lithium-ion secondary battery 100 according to Embodiment 1 will be presented, along with a method of fabricating it.

Fabrication of the Positive Electrodes

First, LiFePO₄ (90 parts by weigh) as an active material, acetylene black (5 parts by weight) as a conductive agent, styrene-butadiene rubber (3 parts by weight) as a binding agent, and CMC (2 parts by weight) as a thickening agent were blended, and then an adequate amount of water was added to and dispersed in the blend; in this way, a positive electrode composite agent slurry was prepared. Next, the positive electrode composite agent slurry was applied evenly to both sides of a charge collector (positive electrode charge collector) of aluminum with a thickness of 20 μm, and was then dried; thereafter, the product was compressed on a roll press so as to have a thickness of 200 μm. Lastly, the product was cut to the desired size; in this way, a positive electrode (positive electrode plate) was fabricated. The size of the region over which the positive electrode active material layer was applied was 150 mm longitudinally by 300 mm laterally, and the size of the positive electrode (positive electrode charge collector) was 150 mm longitudinally by 310 mm laterally.

Fabrication of the Negative Electrodes

First, natural graphite (98 parts by weight) as an active material, styrene-butadiene rubber (1 parts by weight) as a binding agent, and CMC (1 parts by weight) as a thickening agent were blended, and then an adequate amount of water was added to and dispersed in the blend; in this way, a negative electrode composite agent slurry was prepared. Next, the negative electrode composite agent slurry was applied evenly to both sides of a charge collector (negative electrode charge collector) of copper with a thickness of 16 μm, and was then dried; thereafter, the product was compressed on a roll press so as to have a thickness of 350 μm. Lastly, the product was cut to the desired size; in this way, a negative electrode (negative electrode plate) was fabricated. The size of the region over which the negative electrode active material layer was applied was 154 mm longitudinally by 304 mm laterally, and the size of the negative electrode (negative electrode charge collector) was 154 mm longitudinally by 314 mm laterally.

Preparation of the Non-Aqueous Electrolyte Liquid

1 mol/L of LiPF₆ was dissolved in a mixture liquid (solvent) of ethylene carbonate (EC) and diethyl carbonate (DEC) mixed in a ratio of 3:7 by volume; in this way, a non-aqueous electrolyte liquid was prepared.

Assembly of the Secondary Battery

Positive electrode plates and negative electrode plates were stacked with separators interposed between them in the order a positive electrode, a separator, a negative electrode, a separator, and so forth, and in this way, an electrode assembly (stacked member) was formed. Here, so that negative electrode plates may be located outside positive electrode plates, 50 positive electrode plates and 51 negative electrode plates were used. Moreover, 102 separators were used so that separators may be located at the outermost sides of the electrode assembly (stacked member).

The separators were formed of microporous film of polyethylene with a thickness of 20 μm. The size of the separators was 160 mm longitudinally by 310 mm laterally so as to be larger than the size over which the active material layers were applied to the positive and negative electrode plates.

For the package container, a package can and a lid plate were formed by processing a nickel-plated steel plate with a thickness of about 0.8 mm. The package can had the following inside dimensions: in the bottom face portion, 180 mm longitudinally by 350 mm laterally; and 20 mm in depth. On the package can, there were formed a positive electrode terminal of aluminum with a stainless base and a negative electrode terminal of copper with a stainless base.

Then, the electrode assembly (stacked member) was housed in the package can, the lid plate was placed on top, and the battery was sealed therewith by double-seam sealing. The depth of the recess formed by the panel portion and the chuck wall portion of the lid plate (the height of the chuck wall portion) after sealing was 12 mm. Fitting the lid plate caused a pressing force to be applied to the electrode assembly in the stack direction. Here, the pressing force was applied to the electrode assembly with the lid plate in such a way that the proportion of the amount of pressing-in with respect to the thickness of the electrode assembly in the stack direction was 10%. Specifically, the lid plate was fixed at a position about 1 mm pressed in (sunk) from the state where the electrode assembly and the lid plate are in direct or indirect contact with each other.

Next, through a filling hole with a diameter of 2 mm previously provided in the lid plate, a predetermined amount of non-aqueous electrolyte liquid was injected under reduced pressure. After the injection, a metal ball with substantially the same diameter as the filling hole was placed in the filling hole, and the filling hole was stopped by electric resistance welding. In this way, the lithium-ion secondary battery 100 was obtained.

### Embodiment 2

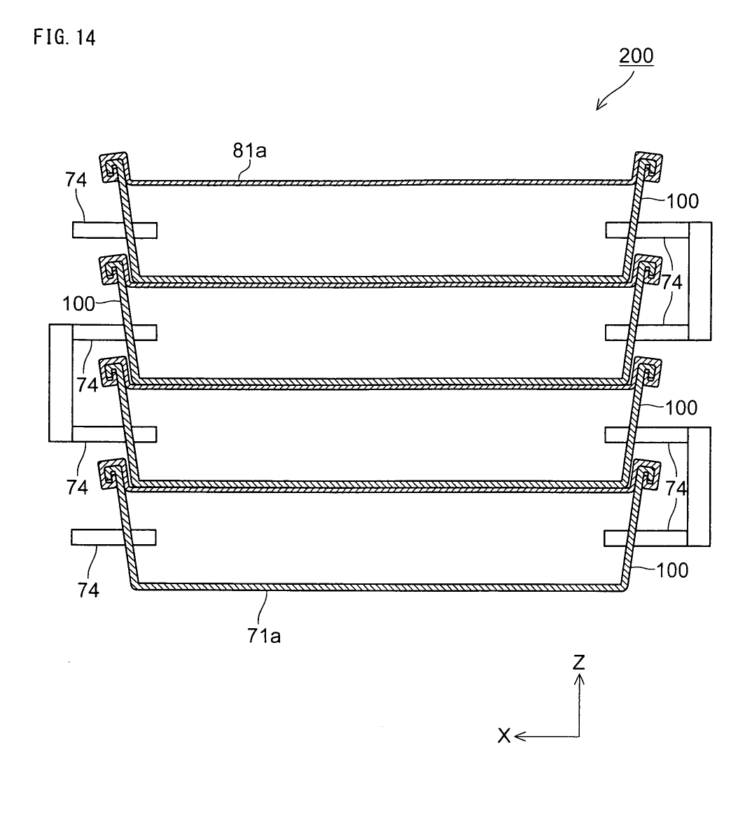

FIG. 14 is a front sectional view of an assembled battery according to a second embodiment (Embodiment 2) of the invention. In FIG. 14, the components inside the battery, such as the electrode assembly, are omitted from illustration. The assembled battery 200 is composed of four lithium-ion secondary batteries 100 stacked together, with the outer bottom face 71a of one substantially fitted into the outer top face 81a of the next, and with electrode terminals 74 connected as necessary. There is no particular restriction on the number of lithium-ion secondary batteries 100 constituting the assembled battery; any number equal to or greater than two will do.

As described previously, since the outer top face 81a forming the recess in the lid plate 80 is substantially rectangular and slightly larger than the outer bottom face 71a, when lithium-ion secondary batteries 100 are stacked on top of one another, the outer bottom face 71a of one battery substantially fits into the outer top face 81a of the next. This permits easy positioning and easy stacking. Moreover, after the stacking, no dislocation occurs.

The assembled battery 200 of this type, compared with an assembled battery formed by stacking together secondary batteries employing a laminate film, has sufficient rigidity in the package container 60, and thus does not need to be covered in a package member such as a metal can even when a considerable number of lithium-ion secondary batteries 100 are stacked together. Thus, simply stacking together a number of battery cells to obtain the desired capacity permits their use as an assembled battery. This helps reduce the number of components and reduce cost.

### Embodiment 3

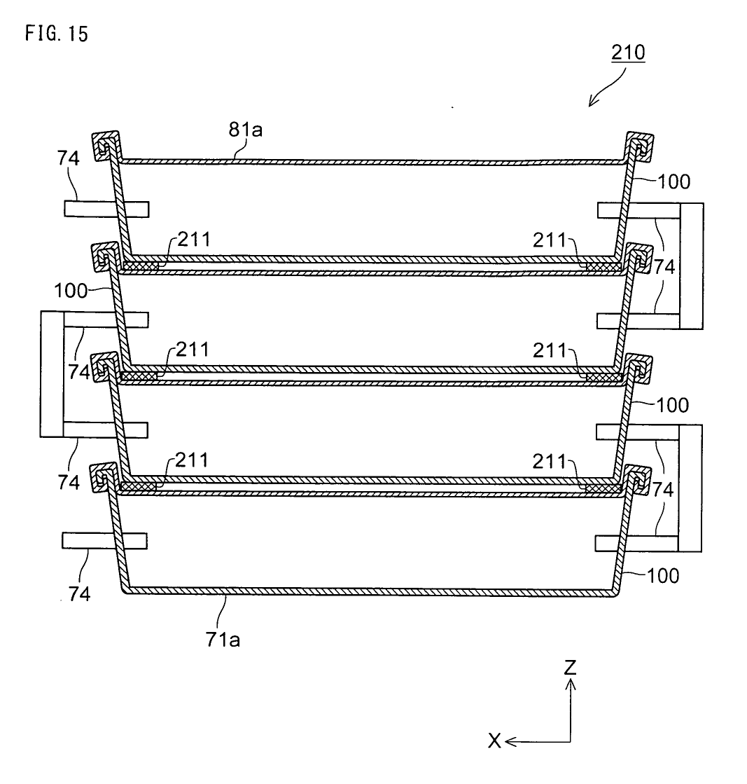

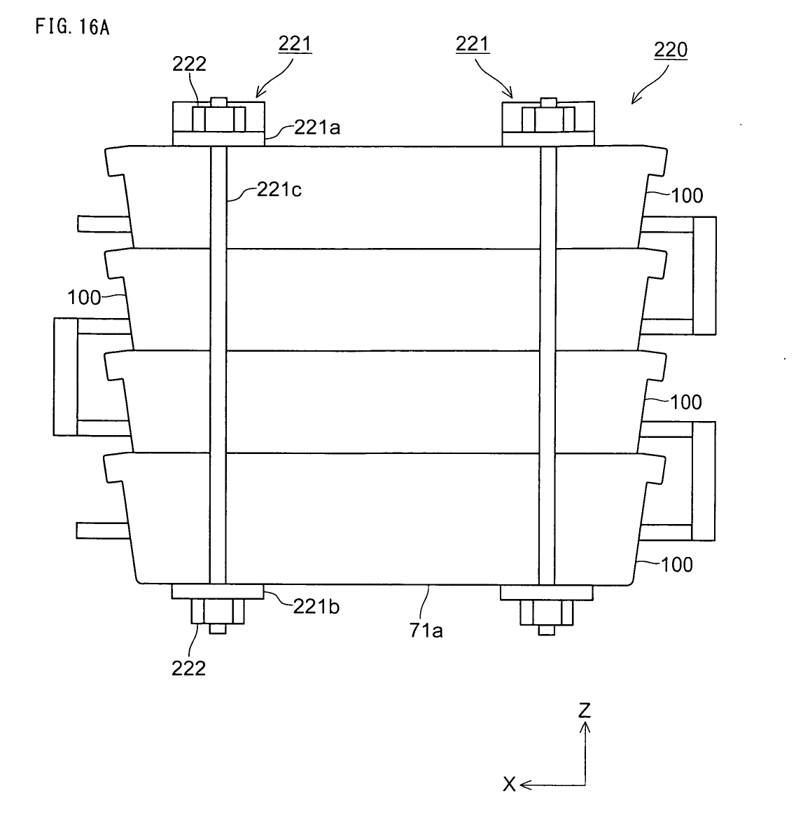

FIG. 15 is a front sectional view of an assembled battery according to a third embodiment (Embodiment 3) of the invention. In FIG. 15, the components inside the battery, such as the electrode assembly, are omitted from illustration. The assembled battery 210 according to Embodiment 3 differs from the assembled battery 200 according to Embodiment 2 in that cushioning members 211 are additionally provided between adjacent lithium-ion secondary batteries 100.

The cushioning members 211 may be provided in any shape and in any number so long as they are placed between the outer bottom face 71a of the package can 70 and the outer top face 81a of the lid plate 80 and they do not hamper the fitting between lithium-ion secondary batteries 100. For example, in FIG. 15, the cushioning members 211 are arranged one at each of the four corners of each surface of fitting. Preferably, the cushioning members 211 are formed of resin or rubber.

With the assembled battery 210 of this type, impact and vibration are absorbed by the cushioning members 211. Moreover, providing the cushioning members 211 leaves space between lithium-ion secondary batteries 100, and this contributes to cooling.

### Embodiment 4

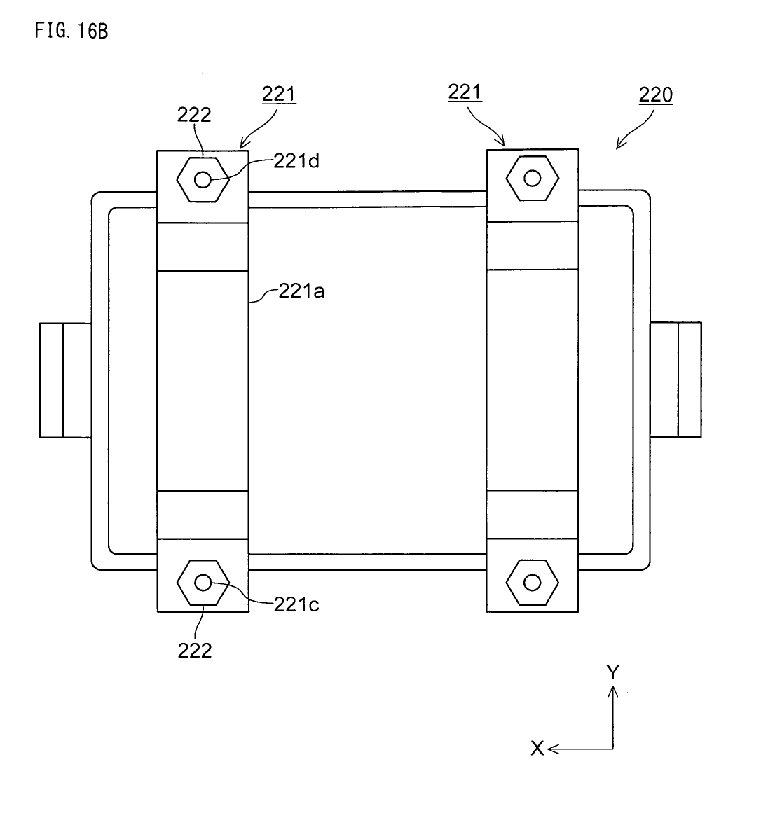

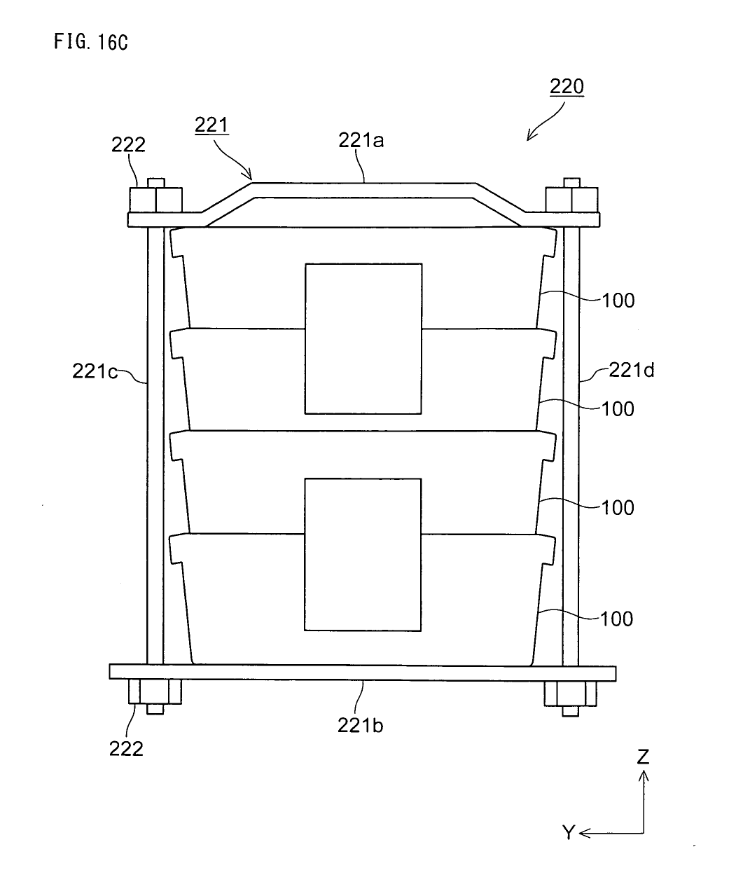

FIG. 16A is a front view of an assembled battery according to a fourth embodiment (Embodiment 4) of the invention, FIG. 16B is a top view of the same, and FIG. 16C is a side view of the same. The assembled battery 220 according to Embodiment 4 differs from the assembled battery 200 according to Embodiment 2 in that two clamping members 221 are additionally provided.

In FIGS. 16A to 16C, the clamping members 221 are so structured as to clamp the bottommost and topmost lithium-ion secondary batteries 100 against each other. Specifically, the clamping members 221 are composed of top face members 221a which traverse the outer top face 81a of the topmost lithium-ion secondary battery 100 in its shorter-side direction (Y direction), bottom face members 221b which traverse the outer bottom face 71a of the bottommost lithium-ion secondary battery 100 in its shorter-side direction (Y direction), front face members 221c which are connected to the top face members 221a and the bottom face members 221b and which traverse the front face of the assembled battery 220 in the up/down direction (Z direction), and rear face members 221d which are connected to the top face members 221a and the bottom face members 221b and which traverse the rear face of the assembled battery 220 in the up/down direction (Z direction).

The top face members 221a and the bottom face members 221b are plate-shaped members; in their parts protruding frontward, there are formed through holes through which the front face members 221c are put, and in their parts protruding rearward, there are formed through holes through which the rear face members 221d are put. Parts of the top face members 221a around their middle are bent upward to be elevated, so as to leave space between the top face members 221a and the outer top face 81a of the topmost lithium-ion secondary battery 100. This space permits the assembled battery 220 to be carried around with the top face members 221a held in hands as handles.

The front face members 221c and the rear face members 221d are bar-shaped member having an external thread formed at each end. Their external-thread parts are put through the through holes in the top face members 221a and the bottom face members 221b, and fastens with nuts 222. This causes the clamping members 221 to clamp the bottommost and topmost lithium-ion secondary batteries 100 against each other.

The clamping members 221 have at least to be so structured as to clamp the bottommost and topmost lithium-ion secondary batteries 100 against each other; they may be so structured as to clamp or hold any middle lithium-ion secondary battery 100 in addition. The clamping members 221 are formed of metal or resin that is rigid enough to withstand the weight of the assembled battery.

With the assembled battery 220 of this type, the clamping members 221 rigidly hold together the lithium-ion secondary batteries 100, resulting in enhanced resistance to impact and vibration. Moreover, providing handles at the top face of the clamping members 221 makes it easy to carry the assembled battery 220 around.

It should be understood that all the embodiments and examples presented herein are in every respect illustrative and not restrictive. The scope of the present invention is defined not by the embodiments and examples described above but by the appended claims, and the invention encompasses any variations and modifications in the sense and scope equivalent to those of the claims.

For example, although the embodiments described above deal with examples where the invention is applied to a lithium-ion secondary battery of a stacked type, this is not meant to limit the invention; the invention may be applied to a lithium-ion secondary battery of a wound type.

Although the embodiments described above deal with examples where the invention is applied to a lithium-ion secondary battery (non-aqueous electrolyte secondary battery) as an example of a secondary battery, this is not meant to limit the invention; the invention may be applied to a non-aqueous electrolyte secondary battery other than a lithium-ion secondary battery, and may also be applied to a secondary battery other than a non-aqueous electrolyte secondary battery. The invention is applicable even to secondary batteries that are yet to be developed.

Although the embodiments described above deal with examples where an active material layer is formed on both sides of a charge collector, this is not meant to limit the invention; an active material layer may be formed on only one side of a charge collector. The electrode assembly may partly include electrodes (positive, negative) having an active material layer formed on only one side of a charge collector. A swelling resin that swells when soaked with a non-aqueous electrolyte liquid may be dispersed in the active material layer of electrodes. Usable as the swelling resin is, for example, one containing one or more substances selected from the group consisting of nitrile butadiene rubber (NBR), styrene butadiene rubber (SBR), carboxymethyl cellulose (CMC), polyvinylidene fluoride (PVdF), polyvinyl alcohol (PVA), polyethylene oxide (PEO), propylene oxide, polystyrene, and polymethyl methacrylate.

Although the embodiments described above deal with examples where a non-aqueous electrolyte liquid is used as the electrolyte of the secondary battery, this is not meant to limit the invention; any other type of electrolyte than a non-aqueous electrolyte liquid may instead be used, for example, a gel electrolyte, high-polymer solid electrolyte, inorganic solid electrolyte, molten salt, or the like.

Although the embodiments described above deal with examples where the opening of the package can is sealed with the lid plate by double-seam sealing, this is not meant to limit the invention; the opening of the package can may be sealed by any other method than double-seam sealing. For example, the opening of the package can may be sealed by welding the lid plate to the package can.

Although the embodiments described above deal with examples where the negative electrode (negative electrode active material layer) is made larger than the positive electrode (positive electrode active material layer), this is not meant to limit the invention; the positive and negative electrodes (positive and negative electrode active material layers) may be made the same size, or the positive electrode (positive electrode active material layer) may be made larger than the negative electrode (negative electrode active material layer).

Although the embodiments described above deal with examples where the positive and negative electrodes are arranged so that the charge collector-exposed portion of the positive electrodes and the charge collector-exposed portion of the negative electrodes are located at opposite sides, this is not meant to limit the invention; the positive and negative electrodes may be arranged so that the charge collector-exposed portion of the positive electrodes and the charge collector-exposed portion of the negative electrodes are located at the same side.

Although the embodiments described above deal with examples where a charge collector-exposed portion is formed at one end of charge collectors, this is not meant to limit the invention; a charge collector-exposed portion may be formed, for example, at each end of charge collectors.

Although Embodiment 1 described above deals with an example where the shape in which the outer bottom face of the housing container fits into the outer top face of the lid member is a single rectangular, this is not meant to limit the invention; so long as they substantially fit together, any other shape may be adopted, such as circular, elliptical, polygonal, etc., and in any number.

What is claimed is:

1. A secondary battery comprising:
an electrode assembly including a positive electrode and a negative electrode;
a package container including a housing container in which the electrode assembly is housed and a lid member which seals an opening of the housing container all around a circumference thereof; and
electrolyte liquid directly filling the housing container,
wherein an outer bottom face of the housing container and an outer top face of the lid member are shaped such that one substantially fits into the other.

2. The secondary battery according to claim 1,
wherein the outer bottom face of the housing container and a recess formed in the outer top face of the lid member are shaped such that one substantially fits into the other.

3. The secondary battery according to claim 2,
wherein the outer bottom face of the housing container is substantially rectangular, and the recess in the lid member is substantially rectangular and larger than the outer bottom face of the housing container.

4. The secondary battery according to claim 1,
wherein the opening of the housing container is sealed with the lid member by seam sealing.

5. An assembled battery comprising a plurality of secondary batteries as claimed in claim 1 stacked together with the outer bottom face of one housing container fitted into the outer top face of an adjacent lid member.

6. The assembled battery according to claim 5, further comprising a cushioning member between the outer bottom face of one housing container and the outer top face of an adjacent lid member.

7. The assembled battery according to claim 5, further comprising a clamping member which clamps at least bottommost and topmost secondary batteries against each other.

8. The assembled battery according to claim 7,
wherein the clamping member has a top face member which traverses the outer top face of the topmost secondary battery, and space is left between the top face member and the outer top face of the topmost secondary battery.

9. The assembled battery according to claim 5,
wherein the secondary batteries each have a capacity of 10 Ah or more.
